(19) United States
(12) Patent Application Publication
(10) Pub. No.: US 2007/0047512 A1
(43) Pub. Date: Mar. 1, 2007

(54) WIRELESS COMMUNICATION METHOD AND APPARATUS FOR SELECTING A SERVING CELL AND NODE-B IN AN SC-FDMA SYSTEM

(75) Inventors: Guodong Zhang, Farmingdale, NY (US); Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/459,785

(22) Filed: Jul. 25, 2006

Related U.S. Application Data
(60) Provisional application No. 60/711,592, filed on Aug. 26, 2005.

(51) Int. Cl. H04J 1/00

(52) U.S. Cl. 370/343; 370/328; 370/395.2

(57) ABSTRACT

A method and apparatus for selecting a serving cell/Node-B in a single carrier frequency division multiple access (SC-FDMA) system are disclosed. For intra-Node-B serving cell selection, a serving Node-B measures channel quality indicators (CQIs) of each subcarrier block in an uplink of each cell controlled by the serving Node-B and selects a new serving cell based on the CQIs. The serving Node-B reports the selected new serving cell to a wireless transmit/receive unit (WTRU). For inter-Node-B serving cell selection, each of a plurality of Node-Bs measures a CQI of each of a plurality of subcarrier blocks in an uplink transmission in each cell controlled by each Node-B and forwards the CQIs to a serving cell selection entity. The serving cell selection entity selects a new serving cell/Node-B based on the CQIs. The serving cell selection entity may be a centralized access gateway, a current serving Node-B or a WTRU.

### CROSS REFERENCE TO RELATED APPLICATION

This application claims the benefit of U.S. Provisional Application No. 60/711,592 filed Aug. 26, 2005, which is incorporated by reference as if fully set forth.

### FIELD OF INVENTION

The present invention is related to a wireless communication system including at lease one wireless transmit/receive unit (WTRU), at least one Node-B and a plurality of cells. More particularly, the present invention is related to a method and apparatus for selecting a serving cell and Node-B in a single carrier frequency division multiple access (SC-FDMA) system.

### BACKGROUND

The third generation partnership project (3GPP) and 3GPP2 are currently considering a long term evolution (LTE) of the universal mobile telecommunication system (UMTS) terrestrial radio access (UTRA). Currently, SC-FDMA is being considered for the uplink of the evolved UTRA.

In an SC-FDMA system, a plurality of orthogonal subcarriers are transmitted simultaneously. The subcarriers are divided into a plurality of subcarrier blocks, (also known as “resource blocks”). A subcarrier block may be a localized subcarrier block or a distributed subcarrier block. The localized subcarrier block is defined as a set of consecutive subcarriers and the distributed subcarrier block is defined as a set of non-consecutive subcarriers. FIG. 1 illustrates two localized subcarrier blocks, each comprising four consecutive subcarriers. A subcarrier block is a basic scheduling unit for uplink transmissions in a conventional SC-FDMA system. Depending on a data rate or a buffer status, a Node-B assigns at least one subcarrier block for uplink transmission for a WTRU.

For uplink macro diversity, (either inter-Node-B or intra-Node-B macro diversity), soft handover or fast cell selection may be performed. In a conventional wideband code division multiple access (WCDMA), a serving cell/Node-B selection for soft handover or fast cell selection is based on channel quality indicator (CQI) measurements of the uplink. One CQI measurement of the entire bandwidth in the uplink for each cell/Node-B is used to make the serving cell/Node-B selection. However, in the SC-FDMA system, there is one CQI per subcarrier block. Therefore, there are multiple CQIs for the uplink per cell. In addition, a WTRU usually does not transmit data using the whole bandwidth. Therefore, it is desirable to provide an improved method for serving cell/Node-B selection in SC-FDMA.

### SUMMARY

The present invention is related to serving cell and Node-B selection in a SC-FDMA system. For intra-Node-B serving cell selection, a serving Node-B measures CQIs of each subcarrier block in an uplink of each cell controlled by the serving Node-B and selects a new serving cell based on the CQIs. The serving Node-B reports the selected new serving cell to a WTRU. For inter-Node-B serving cell selection, each of a plurality of Node-Bs measures a CQI of each of a plurality of subcarrier blocks in an uplink transmission in each cell controlled by each Node-B and forwards the CQIs to a serving cell selection entity. The serving cell selection entity selects a new serving cell/Node-B based on the CQIs. The serving cell selection entity may be a centralized control-plane access gateway, a current serving Node-B or a WTRU.

### BRIEF DESCRIPTION OF THE DRAWINGS

FIG. 1 illustrates a plurality of localized subcarrier blocks associated with uplink transmissions in a conventional SC-FDMA system.

FIG. 2 shows an exemplary wireless communication system configured in accordance with the present invention.

FIG. 3 is a flow diagram of an intra-Node-B cell selection process implemented in the system of FIG. 2 in accordance with a first embodiment of the present invention.

FIG. 4 is a flow diagram of an inter-Node-B cell selection process implemented in the system of FIG. 2 in accordance with a second embodiment of the present invention.

FIG. 5 is a flow diagram of an inter-Node-B cell selection process implemented in the system of FIG. 2 in accordance with a third embodiment of the present invention.

FIG. 6 is a flow diagram of an inter-Node-B cell selection process implemented in the system of FIG. 2 in accordance with a fourth embodiment of the present invention.

FIG. 7 is a flow diagram of an inter-Node-B cell selection process implemented in the system of FIG. 2 in accordance with a fifth embodiment of the present invention.

FIG. 8 is a block diagram of a Node-B used in the system of FIG. 2 in accordance with the present invention.

FIG. 9 is a block diagram of a WTRU used in the system of FIG. 2 in accordance with the present invention.

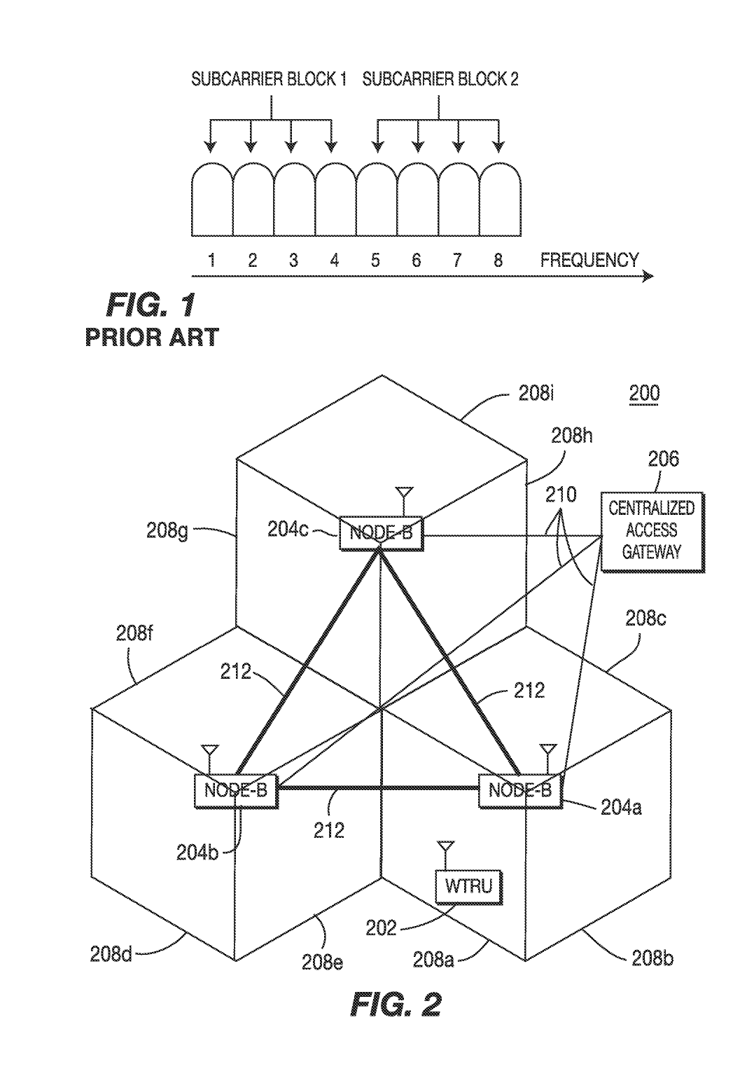

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point (AP) or any other type of interfacing device in a wireless environment.

The features of the present invention may be incorporated into an integrated circuit (IC) or be configured in a circuit comprising a multitude of interconnecting components.

FIG. 2 shows an exemplary wireless communication system 200 configured in accordance with the present invention. The system 200 includes at least one WTRU 202, a plurality of Node-Bs 204a-204c, a plurality of cells 208a-208i and an optional centralized access gateway (aGW) 206. The Node-B 204a controls the cells 208a-208c, the Node-B 204b controls the cells 208d-208f, and the Node-B 204c controls the cells 208g-208i. The WTRU 202 is currently connected to the cell 208a, (i.e., serving cell), and the Node-B 204a, (i.e., serving Node-B). The Node-Bs 204a-204c may be connected to each other via a high speed link 212. The centralized aGW 206 may also be connected to the Node-Bs 204a-204c via a high speed link 210.

Where only one Node-B, such as Node-B 204a, is involved in a serving cell/Node-B selection and two or more cells, such as cells 208a-208c, are controlled by the Node-B, such as Node-B 204a, an intra-Node-B cell selection is performed. There are two possible macro diversity schemes. One is soft handover and the other is fast cell selection. In soft handover, a transmission from a WTRU 202 is received and processed by several cells, (e.g., cells 208a-208c), controlled by the same Node-B, (e.g., Node-B 204a). Among those cells, one cell is designated as a serving cell, (e.g., cell 208a). In fast cell selection, a transmission from the WTRU 202 is received and processed only by the serving cell 208a, and the WTRU 202 may switch from one cell to another very quickly to achieve a “best” radio link.

For both handover and fast cell selection, the same serving cell selection procedure is implemented in accordance with the present invention. The major difference between the serving cell selection in soft handover and fast cell selection is the frequency that the serving cell selection is performed. The uplink serving cell selection for soft handover may be performed as fast as one per several transmission time intervals (TTIs); whereas the uplink fast cell selection may be performed as fast as one per TTI or per several TTIs, which should be faster than the intra-Node-B soft handover. The time interval that the uplink serving cell selection may be performed is called uplink intra-Node-B serving cell selection interval.

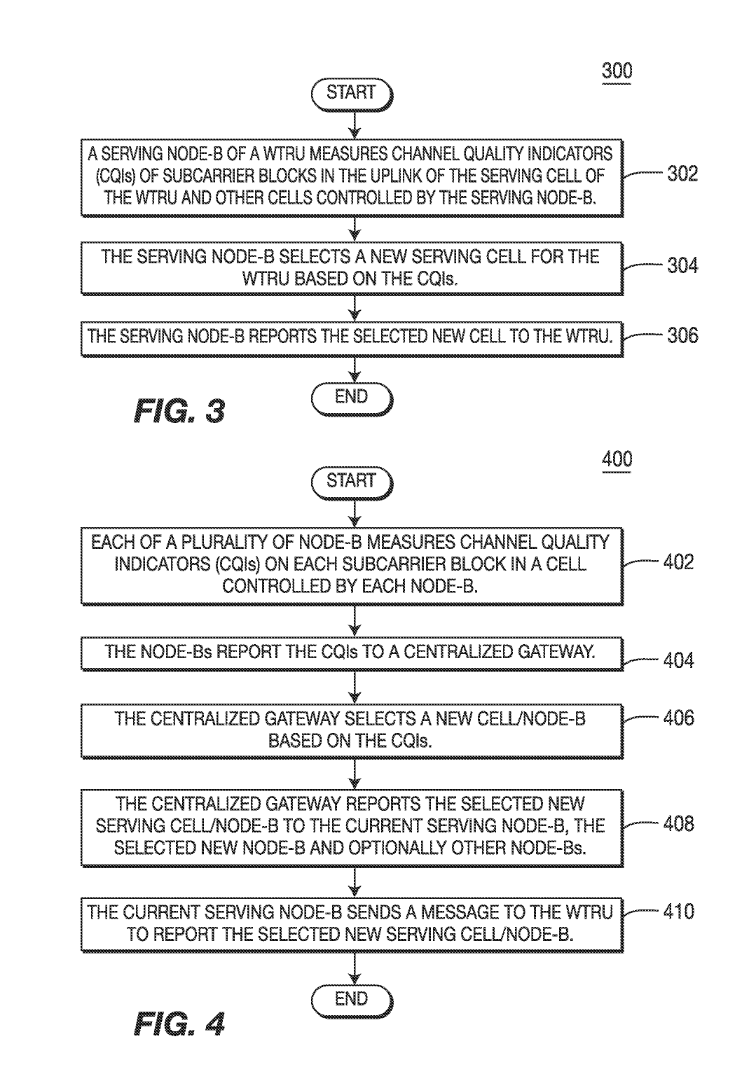

FIG. 3 is a flow diagram of an intra-Node-B cell selection process 300 implemented in the system 200 of FIG. 2 in accordance with a first embodiment of the present invention. Where two or more cells are controlled by the same Node-B, an intra-Node-B cell selection is performed. A serving Node-B 204a of a WTRU 202 measures CQIs of subcarrier blocks in an uplink transmission transmitted by the WTRU 202 in the serving cell 208a of the WTRU 202 and other cells 208b-208c controlled by the serving Node-B 204a (step 302). The serving Node-B 204a preferably considers CQIs of the best K subcarrier blocks of each cell 208a-208c controlled by the serving Node-B 204a. The K subcarrier blocks are those that have the K best CQIs among all N subcarrier blocks within a cell 208a-208c. Based on the uplink data rate of the WTRU 202, the WTRU 202 may be assigned to M subcarrier blocks (1≦M≦N). The value of K is a design parameter, which satisfies M≦K≦N.

The serving Node-B 204a selects a new serving cell for the WTRU 202 based on the CQIs (step 304). For example, the Node-B 204a may simply select a new serving cell that has the best average or weighted average CQI of M subcarrier blocks out of the K subcarrier blocks. Alternatively, the Node-B 204a may select the new serving cell for the WTRU 202 by considering both CQIs, (i.e., CQIs of the WTRU 202 and other WTRUs in the cells 208a-208c controlled by the Node-B 204a), and scheduling strategy. For example, an appropriate scheduling strategy may balance the cell loads based on the number of WTRUs transmitting in the cells and their data rate and channel conditions, (e.g., uplink CQIs).

The serving Node-B 204a then reports the selected new cell to the WTRU 202, (preferably via a downlink shared control channel), (step 306). The process 300 is repeated every uplink serving cell selection interval.

Where several Node-Bs are involved with the serving cell/Node-B selection, an inter-Node-B cell/Node-B selection is performed. The inter-Node-B cell/Node-B selection decision is made by a serving cell selection entity. The serving cell selection entity may be a centralized aGW 206, a current serving Node-B 204a, a WTRU 202 or any other entity in the network, depending on the network architecture.

There are two possible macro diversity schemes for the inter-Node-B cell/Node-B selection. One scheme is soft handover and the other is fast cell selection. In soft handover, a transmission from the WTRU 202 is received and processed by several cells 208a-208i controlled by different Node-Bs 204a-204c. Among those cells, one cell is designated as a serving cell, (e.g., cell 208a). A Node-B, (e.g., Node-B 204a), that controls the serving cell is called a serving Node-B. The WTRU 202 may receive scheduling information, (i.e., at which subcarrier blocks to transmit), only from the serving Node-B 204a. In fast cell selection, a transmission from the WTRU 202 is received and processed by cells 208a-208c controlled by the serving Node-B 204a. The WTRU 202 may switch from one Node-B to another very quickly to get the “best” radio link.

For both handover and fast cell selection, the same serving cell selection procedure is implemented in accordance with the present invention. The major difference between the serving cell/Node-B selection for soft handover and fast cell selection is the frequency that the serving cell/Node-B selection may be performed. Basically, the fast cell selection may be performed faster than the serving cell/Node-B selection in soft handover. The time interval that uplink serving cell/Node-B selection is performed is called uplink inter-Node-B serving cell/Node-B selection interval.

FIG. 4 is a flow diagram of an inter-Node-B cell selection process 400 implemented in the system 200 of FIG. 2 in accordance with a second embodiment of the present invention. Each of a plurality of Node-Bs 204a-204c measures CQIs on each subcarrier block in a cell 208a-208i controlled by each Node-B 204a-204c (step 402). For the inter-Node-B fast cell selection, only a serving Node-B 204a processes data received from the WTRU 202, while other Node-Bs 204b-204c ignore the data. However, other Node-Bs 204b-204c should process pilot signals transmitted by the WTRU 202 to measure the CQIs on uplink transmissions by the WTRU 202.

The Node-Bs 204a-204c report the CQIs to a centralized aGW 206 (step 404). The centralized aGW 206 connects several Node-Bs via a high-speed link 210. Each Node-B 204a-204c preferably reports CQIs of the best K subcarrier blocks of each cell controlled by the Node-B 204a-204c. The K subcarrier blocks are those that have the K best CQIs among all N subcarrier blocks within a cell. To reduce the signaling overhead, each Node-B 204a-204c may report CQIs of the cell that has the best K CQIs, (e.g., in terms of average CQI), among the cells controlled by the Node-B 204a-204c.

The centralized aGW 206 then selects a new cell/Node-B based on the CQIs (step 406). For example, the centralized aGW 206 may simply select the cell/Node-B that has the best average or weighted average CQI of M subcarrier blocks out of the K subcarrier blocks. Alternatively, the centralized aGW 206 may select a cell/Node-B by considering both CQIs of the WTRU 202 and other WTRUs in the cells 208a-208i controlled by the Node-Bs 204a-204c and scheduling strategy.

The centralized aGW 206 sends messages to the current serving Node-B 204a, the new Node-B, (e.g., Node-B 204b), which controls the selected new cell and optionally other Node-Bs, (e.g., Node-B 204c), to report the selected new serving cell/Node-B (step 408). The current serving Node-B 204a sends a message to the WTRU 202 to report the selected new serving cell/Node-B, (preferably via a downlink shared control channel), (step 410). The process 400 is repeated every uplink inter-Node-B serving cell/Node-B selection interval.

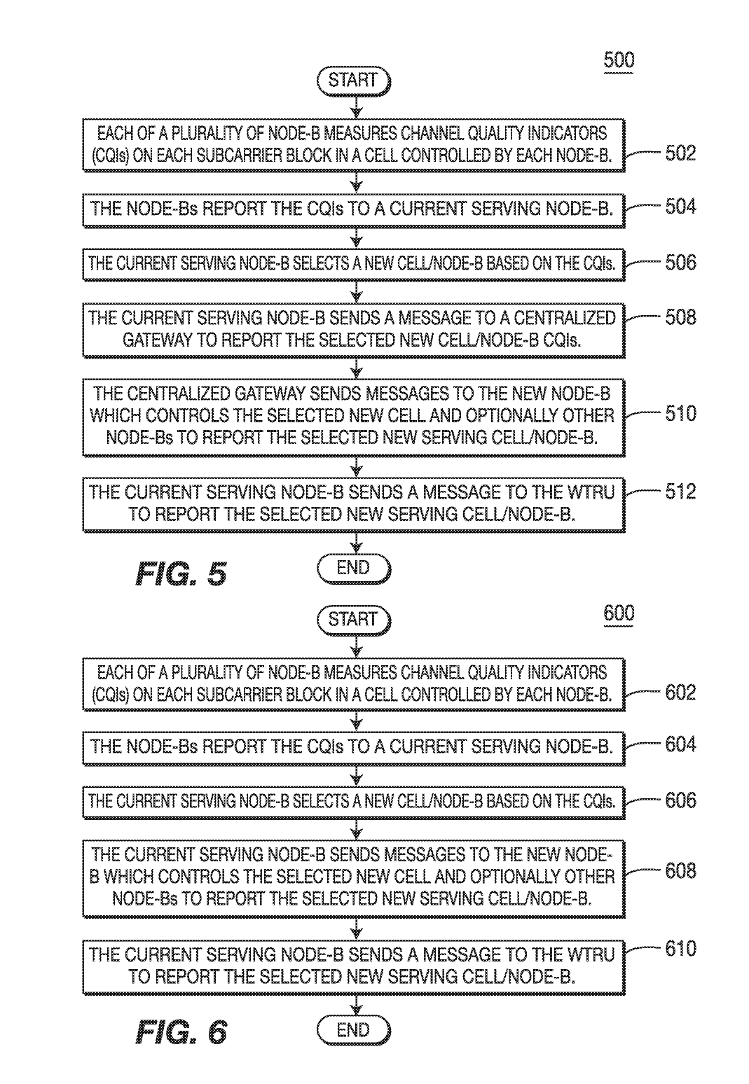

FIG. 5 is a flow diagram of an inter-Node-B cell selection process 500 implemented in the system 200 of FIG. 2 in accordance with a third embodiment of the present invention. Each of a plurality of Node-Bs 204a-204c measures CQIs on each subcarrier block in a cell 208a-208i controlled by each Node-B 204a-204c (step 502). The Node-Bs 204a-204c process pilot signals transmitted by the WTRU 202 to measure the CQI on uplink transmissions by the WTRU 202.

Non-serving Node-Bs 204b-204c report the CQIs to a current serving Node-B 204a (step 504). Each non-serving Node-B 204b-204c preferably reports CQIs of the best K subcarrier blocks of each cell 208d-208i controlled by the non-serving Node-B 204b-204c. The K subcarrier blocks are those that have the K best CQIs among all N subcarrier blocks within a cell. To reduce the signaling overhead, each non-serving Node-B 204b-204c may report CQIs of the cell that has the best K CQIs, (e.g., in terms of average CQI), among the cells controlled by the non-serving Node-B 204b-204c.

The current serving Node-B 204a then selects a new cell/Node-B based on the CQIs (step 506). For example, the serving Node-B 204a may simply select the cell/Node-B that has the best average or weighted average CQI of M subcarrier blocks out of the K subcarrier blocks. Alternatively, the serving Node-B 204a may select a cell/Node-B by considering both CQIs of the WTRU 202 and other WTRUs in the cells controlled by the Node-Bs 204a-204c and scheduling strategy.

The current serving Node-B 204a sends a message to a centralized aGW 206 to report the selected new cell/Node-B (step 508). The centralized aGW 206 connects several Node-Bs 204a-204c via a high-speed link. The centralized aGW 206 then forwards the messages to the selected new Node-B, (e.g., Node-B 204b), which controls the selected new cell and optionally other Node-Bs, (e.g., Node-B 204c), to report the selected new serving cell/Node-B (step 510).

The current serving Node-B 204a sends a message to the WTRU 202 to report the selected new serving cell/Node-B, (preferably via a downlink shared control channel), (step 512). The process 500 is repeated every uplink inter-Node-B serving cell/Node-B selection interval.

FIG. 6 is a flow diagram of an inter-Node-B cell selection process 600 implemented in the system 200 of FIG. 2 in accordance with a fourth embodiment of the present invention. Each of a plurality of Node-Bs 204a-204c measures CQIs on each subcarrier block in a cell 208a-208i controlled by each Node-B 204a-204c (step 602). The Node-Bs 204a-204c process pilot signals transmitted by the WTRU 202 to measure the CQI on uplink transmissions by the WTRU 202.

Non-serving Node-Bs 204b-204c report the CQIs to a current serving Node-B 204a (step 604). Each non-serving Node-B 204b-204c preferably reports CQIs of the best K subcarrier blocks of each cell controlled by the non-serving Node-B 204b-204c. The K subcarrier blocks are those that have the K best CQIs among all N subcarrier blocks within a cell. To reduce the signaling overhead, each non-serving Node-B 204b-204c may report CQIs of the cell that has the best K CQIs, (e.g., in terms of average CQI), among the cells controlled by the non-serving Node-B 204b-204c.

The current serving Node-B 204a then selects a new cell/Node-B based on the CQIs (step 606). For example, the serving Node-B 204a may simply select the cell/Node-B that has the best average or weighted average CQI of M subcarrier blocks out of the K subcarrier blocks. Alternatively, the serving Node-B 204a may select a cell/Node-B by considering both CQIs of the WTRU 202 and other WTRUs in the cells controlled by the Node-Bs 204a-204c and scheduling strategy.

The current serving Node-B 204a sends messages to the selected new Node-B, (e.g., Node-B 204b), which controls the selected new cell and optionally other Node-Bs, (e.g., Node-B 204c), to report the selected new serving cell/Node-B via a high-speed link 212 connecting the Node-Bs 204a-204c to each other (step 608). The current serving Node-B 204a sends a message to the WTRU 202 to report the selected new serving cell/Node-B, (preferably via a downlink shared control channel), (step 610). The process 600 is repeated every uplink inter-Node-B serving cell/Node-B selection interval.

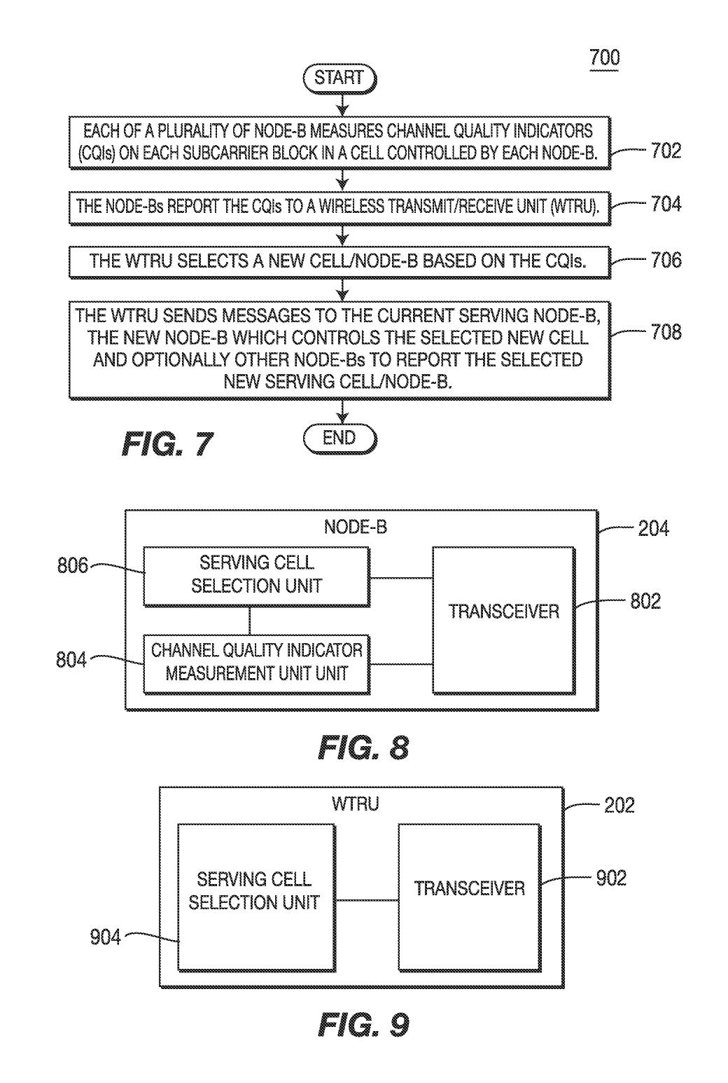

FIG. 7 is a flow diagram of an inter-Node-B cell selection process 700 implemented in the system 200 of FIG. 2 in accordance with a fifth embodiment of the present invention. Each of a plurality of Node-Bs 204a-204c measures CQIs on each subcarrier block in a cell 208a-208i controlled by each Node-B 204a-204c (step 702). The Node-Bs 204a-204c process pilot signals transmitted by the WTRU 202 to measure the CQI on uplink transmissions by the WTRU 202.

The Node-Bs 204a-204c report the CQIs to the WTRU 202 (step 704). Each Node-B 204a-204c preferably reports CQIs of the best K subcarrier blocks of each cell 208a-208i controlled by the Node-B 204a-204c. The K subcarrier blocks are those that have the K best CQIs among all N subcarrier blocks within a cell 208a-208i. To reduce the signaling overhead, each Node-B 204a-204c may report CQIs of the cell that has the best K CQIs, (e.g., in terms of average CQI), among the cells 208a-208i controlled by the Node-B 204a-204c.

The WTRU 202 then selects a new cell/Node-B based on the CQIs (step 706). For example, the WTRU 202 may simply select the cell/Node-B that has the best average or weighted average CQI of M subcarrier blocks out of the K subcarrier blocks.

The WTRU 202 sends messages to the current serving Node-B 204a, the selected new Node-B, (e.g., Node-B 204b), which controls the selected new cell and optionally other Node-Bs, (e.g., Node-B 204c), to report the selected new serving cell/Node-B (step 708). The process 700 is repeated every uplink inter-Node-B serving cell/Node-B selection interval.

FIG. 8 is an exemplary block diagram of a Node-B 204 configured in accordance with the present invention. The Node-B 204 includes a transceiver 802, a CQI measurement unit 804 and a serving cell selection unit 806. The transceiver 802 receives uplink transmissions transmitted by a WTRU 202 and sends messages to the WTRU 202. The CQI measurement unit 804 measures CQIs of each subcarrier block in the uplink transmission in each cell controlled by the Node-B 204. The serving cell selection unit 806 selects a new serving cell based on the CQIs and sends a message to the WTRU 202 which indicates the selected new serving cell.

FIG. 9 is an exemplary block diagram of a WTRU 202 configured in accordance with the present invention. The WTRU 202 includes a transceiver 902 and a serving cell selection unit 904. The WTRU 202 receives CQIs from the Node-Bs 204a-204c and the serving cell selection unit 904 selects a new serving cell based on the CQIs. The transceiver 902 sends messages to a current serving Node-B and a selected new Node-B and/or other Node-Bs which indicate the selected new serving cell.

Although the features and elements of the present invention are described in particular combinations, each feature or element can be used alone without the other features and elements of the preferred embodiments or in various combinations with or without other features and elements of the present invention.

What is claimed is:

1. In a single carrier frequency division multiple access (SC-FDMA) system including at least one wireless transmit/receive unit (WTRU), at least one Node-B and a plurality of cells, a method of selecting a serving cell, the method comprising:
the Node-B measuring a channel quality indicator (CQI) of each of a plurality of subcarrier blocks in the uplink of each cell controlled by the Node-B;
the Node-B selecting a new serving cell based on the CQIs; and
the Node-B reporting the selected new serving cell to the WTRU.

2. The method of claim 1 wherein the Node-B considers CQIs of the best K subcarrier blocks of each cell.

3. The method of claim 1 wherein the Node-B selects the new serving cell that has a best average CQI.

4. The method of claim 1 wherein the Node-B selects the new serving cell that has a best weighted average CQI.

5. The method of claim 1 wherein the Node-B selects the new serving cell by considering at least one of CQIs of other WTRUs and scheduling strategy.

6. The method of claim 1 wherein the Node-B reports the selected new serving cell to the WTRU via a downlink shared control channel.

7. In a single carrier frequency division multiple access (SC-FDMA) system including at least one wireless transmit/receive unit (WTRU), a plurality of Node-Bs and a plurality of cells, a method of selecting a serving cell/Node-B, the method comprising:
each of the Node-Bs measuring a channel quality indicator (CQI) of each of a plurality of subcarrier blocks in an uplink transmission in each cell controlled by each Node-B;
the Node-Bs forwarding the CQIs to a serving cell selection entity; and
the serving cell selection entity selecting a new serving cell/Node-B based on the CQIs.

8. The method of claim 7 wherein the serving cell selection entity is a centralized access gateway which reports the selected new serving cell/Node-B to a current serving Node-B and a selected new Node-B.

9. The method of claim 8 wherein the centralized access gateway reports the selected new serving cell/Node-B to other Node-Bs.

10. The method of claim 7 wherein the serving cell selection entity is a current serving Node-B of the WTRU and the current serving Node-B reports the selected new serving cell/Node-B to a selected new Node-B.

11. The method of claim 10 wherein the current serving Node-B reports the selected new serving cell/Node-B to the selected new Node-B via a centralized access gateway.

12. The method of claim 10 wherein the current serving Node-B reports the selected new serving cell/Node-B to the selected new Node-B via a direct connection between the current serving Node-B and the new Node-B.

13. The method of claim 10 wherein the current serving Node-B reports the selected new serving cell/Node-B to other Node-Bs.

14. The method of claim 7 wherein the serving cell selection entity is the WTRU and the WTRU sends a message to a current serving Node-B and a selected new Node-B to report the selected new serving cell/Node-B.

15. The method of claim 7 wherein the Node-Bs process pilot signals transmitted by the WTRU to measure the CQIs.

16. The method of claim 7 wherein each Node-B reports CQIs of the best K subcarrier blocks of each cell controlled by the Node-B.

17. The method of claim 7 wherein each Node-B reports CQIs of the cell that has the best K CQIs among the cells controlled by the Node-B.

18. The method of claim 7 wherein the serving cell selection entity selects the new cell/Node-B that has a best average CQI.

19. The method of claim 7 wherein the serving cell selection entity selects the new cell/Node-B that has a best weighted average CQI.

20. The method of claim 7 wherein the serving cell selection entity selects the new cell/Node-B by considering at least one of CQIs of the WTRU and scheduling strategy.

21. In a single carrier frequency division multiple access (SC-FDMA) system including at least one wireless transmit/receive unit (WTRU), at least one Node-B and a plurality of cells, a Node-B for selecting a serving cell, the Node-B comprising:
a transceiver for receiving uplink transmissions and sending a message to the WTRU;
a channel quality indicator (CQI) measurement unit for measuring a CQI of each of a plurality of subcarrier blocks in the uplink transmission in each cell controlled by the Node-B; and
a serving cell selection unit for selecting a new serving cell based on the CQIs and sending a message to the WTRU to report the selected new serving cell.

22. The Node-B of claim 21 wherein the message is sent via a downlink shared control channel.

23. The Node-B of claim 22 wherein the serving cell selection unit considers CQIs of the best K subcarrier blocks of each cell.

24. The Node-B of claim 21 wherein the serving cell selection unit selects the new serving cell that has a best average CQI.

25. The Node-B of claim 21 wherein the serving cell selection unit selects the new serving cell that has a best weighted average CQI.

26. The Node-B of claim 21 wherein the serving cell selection unit selects the new serving cell by considering at least one of CQIs of other WTRUs and scheduling strategy.

27. In a single carrier frequency division multiple access (SC-FDMA) system including at least one wireless transmit/receive unit (WTRU), a plurality of Node-Bs and a plurality of cells, a system for selecting a serving cell/Node-B, the system comprising:
a plurality of Node-Bs, each Node-B configured to measure a channel quality indicator (CQI) of each of a plurality of subcarrier blocks in an uplink transmission in each cell controlled by the Node-B, and report the CQIs to a serving cell selection entity; and
the serving cell selection entity configured to select a new serving cell/Node-B based on the CQIs.

28. The system of claim 27 wherein the serving cell selection entity is a centralized access gateway which reports the selected new serving cell/Node-B to a current serving Node-B and a selected new Node-B.

29. The system of claim 28 wherein the centralized access gateway reports the selected new serving cell/Node-B to other Node-Bs.

30. The system of claim 27 wherein the serving cell selection entity is a current serving Node-B of the WTRU and the current serving Node-B reports the selected new serving cell/Node-N to a selected new Node-B.

31. The system of claim 30 wherein the current serving Node-B reports the selected new serving cell/Node-B to the selected new Node-B via a centralized access gateway.

32. The system of claim 30 wherein the current serving Node-B reports the selected new serving cell/Node-B to the selected new Node-B via a direct connection between the current serving Node-B and the new Node-B.

33. The system of claim 30 wherein the current serving Node-B sends a message to other Node-Bs to report the selected new serving cell/Node-B.

34. The system of claim 27 wherein the serving cell selection entity is the WTRU and the WTRU sends a message to a current serving Node-B and a selected new Node-B to report the selected new serving cell/Node-B.

35. The system of claim 27 wherein the Node-Bs configured to process pilot signals transmitted by the WTRU to measure the CQIs.

36. The system of claim 27 wherein the Node-B reports CQIs of the best K subcarrier blocks of each cell controlled by the Node-B.

37. The system of claim 27 wherein the Node-B reports CQIs of the cell that has the best K CQIs among the cells controlled by the Node-B.

38. The system of claim 27 wherein the serving cell selection entity selects the new cell/Node-B that has a best average CQI.

39. The system of claim 27 wherein the serving cell selection entity selects the new cell/Node-B that has a best weighted average CQI.

40. The system of claim 27 wherein the serving cell selection entity selects the new cell/Node-B by considering at least one of CQIs of other WTRUs and scheduling strategy.

41. In a single carrier frequency division multiple access (SC-FDMA) system including at least one wireless transmit/receive unit (WTRU), a plurality of Node-Bs and a plurality of cells, a WTRU for selecting a serving cell/Node-B, the WTRU comprising:
a serving cell selection unit for selecting a new serving cell/Node-B based on channel quality indicators (CQIs) reported by the Node-Bs, the CQIs being measured for each of a plurality of subcarrier blocks in an uplink transmission in each cell controlled by each Node-B; and
a transceiver for sending a message to a current serving Node-B and a selected new Node-B to report the selected new serving cell/Node-B.
